(19) United States
(12) Patent Application Publication
(10) Pub. No.: US 2003/0000890 A1
(43) Pub. Date: Jan. 2, 2003

(54) Tubular membrane and method of making

(76) Inventors: Nathaniel R. Quick, Lake Mary, FL (US); Michael C. Murray, Eustis, FL (US); Matthew R. June, Daytona Beach, FL (US); Thomas Peloquin JR., New Smyrna Beach, FL (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/158,392

(22) Filed: May 28, 2002

Related U.S. Application Data
(60) Provisional application No. 60/294,149, filed on May 29, 2001.

(51) Int. Cl. B01D 39/20

(52) U.S. Cl. 210/497.1; 210/510.1; 228/196

(57) ABSTRACT

An improved tubular membrane and process of making is disclosed comprising the deposition of fine metallic fibers onto a substrate. The deposited fine metallic fibers are heated to form a flexible membrane. Catalytically active particles can be dispersed with the fine metallic fibers. The flexible membrane is wound to form a membrane winding. The membrane winding is sintered for forming a substantially rigid tubular membrane.

The benefit under 35 U.S.C. §119(e) of U.S. provisional application entitled TUBULAR MEMBRANE AND METHOD, Serial No. 60/294,149, filed May 29, 2001, is hereby claimed and the disclosure thereof is hereby incorporated by reference in its entirety.

### BACKGROUND OF THE INVENTION

1. Field of the Invention

This invention relates to membranes for filtration and for other uses and more particularly to an improved tubular membrane and a method of making the same.

2. Description of the Related Art

Metal filters have long been used for a variety of applications. For example, porous stainless steel filters prepared from sintered metal particulate, e.g., stainless steel powder, have found use in a variety of processes where high pressure drops are acceptable and in applications where relatively fine filtration capability must be combined with mechanical strength, resistance to high temperatures and/or resistance to chemical attack. Such applications include the burners for natural gas turbine electricity generating plants and in filters such as fuel filters, compressed gas filters, emission control filters and other solid-gas separations. Still another use of such filters is in the filtration of molten resin used in the manufacture of polymeric films and fibers as, for example, polyester film.

One form of commercially available metal filters in cylindrical form is typically prepared from sheet material which is formed into a cylindrical shape and then longitudinally welded. Unfortunately, this method of manufacture results in a structure sensitive to rapid temperature change, i.e., uneven heating and cooling can ultimately result in cracking and failure of the structure adjacent the seam weld. Other drawbacks to such welded structures are non-uniform blow back characteristics and the inability to make relatively small diameter structures, e.g., at one-half inch diameter, the welded seam occupies a significant portion of the overall surface available for filtration, limiting the onstream filter life for a given cycle

### SUMMARY OF THE INVENTION

One embodiment of the invention is a process of making a tubular membrane from a multiplicity of fine metallic fibers. The process includes suspending the multiplicity of fine metallic fibers within a liquid binder, depositing the fine metallic fibers onto a porous substrate by applying a pressure, thereby forcing the liquid binder through the porous substrate, and heating the deposited fine metallic fibers to form a flexible membrane. The process further includes winding the flexible membrane to form a tubular membrane winding, and sintering the membrane winding to form the tubular membrane.

Another embodiment of the invention is a process of making a membrane from a multiplicity of fine metallic fibers. The process includes suspending the multiplicity of fine metallic fibers within a liquid binder, pouring the fine metallic fibers with the liquid binder onto a porous substrate located within a pressure vessel, applying a pressure to the liquid binder for forcing the liquid binder through the porous substrate, thereby depositing the fine metallic fibers onto the porous substrate, and drying the deposited fine metallic fibers and the porous substrate. The process further includes heating the deposited fine metallic fibers for a time sufficient for adhering the fine metallic fibers to adjacent fine metallic fibers to form a flexible membrane, winding the flexible membrane to form a tubular membrane with multiple overlying layers of the flexible membrane to form membrane winding, and sintering the membrane winding for forming a substantially rigid tubular membrane.

Another embodiment of the invention is a tubular membrane formed from a multiplicity of fine metallic fibers. The tubular membrane includes a flexible sheet of membrane formed from a multiplicity of fine metallic fibers, wherein the flexible sheet of membrane being is wound in multiple overlying layers about a generally central axis to form a membrane winding, and sinter bonds of said membrane winding for bonding the multiple overlying layers to adjacent overlying layers of said flexible sheet of membrane for forming a substantially rigid tubular membrane.

### BRIEF DESCRIPTION OF THE DRAWINGS

These and other objects and features of the invention will become more fully apparent from the following description and appended claims taken in conjunction with the following drawings, where like reference numbers indicate identical or functionally similar elements.

FIG. 1 is a block diagram illustrating a first process of forming a tubular membrane.

FIG. 2 is an isometric view illustrating an initial process of depositing fine metallic fibers onto a porous substrate.

FIG. 3 is an isometric view similar to FIG. 2 illustrating the continued process of depositing fine metallic fibers onto the porous substrate.

FIG. 4 is an isometric view illustrating the removal of the deposited fine metallic fibers from the porous substrate.

FIG. 5 is an isometric view illustrating the heating of the deposited fine metallic fibers to form a flexible membrane.

FIG. 6 is a side view of an optional step of rolling the flexible membrane.

FIG. 7 is an isometric view illustrating the wrapping of the flexible membrane to form a membrane winding.

FIG. 8 is a side view of FIG. 7.

FIG. 9 is a magnified view of a portion of FIG. 8.

FIG. 10 is an isometric view illustrating the sintering of the membrane winding to form the tubular membrane.

FIG. 11 is an exploded view of end caps located adjacent to the ends of the tubular membrane.

FIG. 12 is a view of the end caps engaging with the ends of the tubular membrane.

FIG. 13 is an enlarged sectional view of a portion of FIG. 12.

FIG. 14 is an isometric view illustrating the sintering of the tubular membrane and the end caps.

FIG. 15 is a block diagram illustrating a second process of forming a tubular membrane.

FIG. 16 is an isometric view illustrating initial process of depositing fine metallic fibers onto a porous fiber substrate.

FIG. 17 is an isometric view similar to FIG. 16 illustrating the continued process of depositing fine metallic fibers onto the porous fiber substrate.

FIG. 18 is an isometric view illustrating the deposited fine metallic fibers on the porous fiber substrate.

FIG. 19 is an isometric view illustrating the heating of the deposited fine metallic fibers and the porous fiber substrate to form a flexible membrane.

FIG. 20 is a side view of an optional step of inverting and rolling the flexible membrane.

FIG. 21 is a magnified view of a portion of FIG. 20 illustrating the insertion of a first catalytically active material shown as particles into the porous fiber substrate of the flexible membrane.

FIG. 22 is a magnified view of a portion of FIG. 20 illustrating the insertion of a second catalytically active material shown as fibers into the porous fiber substrate of the flexible membrane.

FIG. 23 is an isometric view illustrating the wrapping of the flexible membrane to form a membrane winding.

FIG. 24 is a side view of FIG. 23.

FIG. 25 is a magnified view of a portion of FIG. 23 illustrating the entrapment of the catalytically active material shown in FIG. 21.

FIG. 26 is a magnified view of a portion of FIG. 23 illustrating the entrapment of the second catalytically active material shown in FIG. 22.

FIG. 27 is an isometric view illustrating the sintering of the membrane winding for forming the tubular membrane with the optional material contained therein.

### DETAILED DESCRIPTION OF THE INVENTION

A detailed description of an embodiment of the invention is provided below. While the invention is described in conjunction with that embodiment, it should be understood that the invention is not limited to any one embodiment. On the contrary, the scope of the invention is limited only by the appended claims, and the invention encompasses numerous alternatives, modifications and equivalents. For the purpose of example, numerous specific details are set forth in the following description in order to provide a thorough understanding of the invention. The invention may be practiced according to the claims without some or all of these specific details.

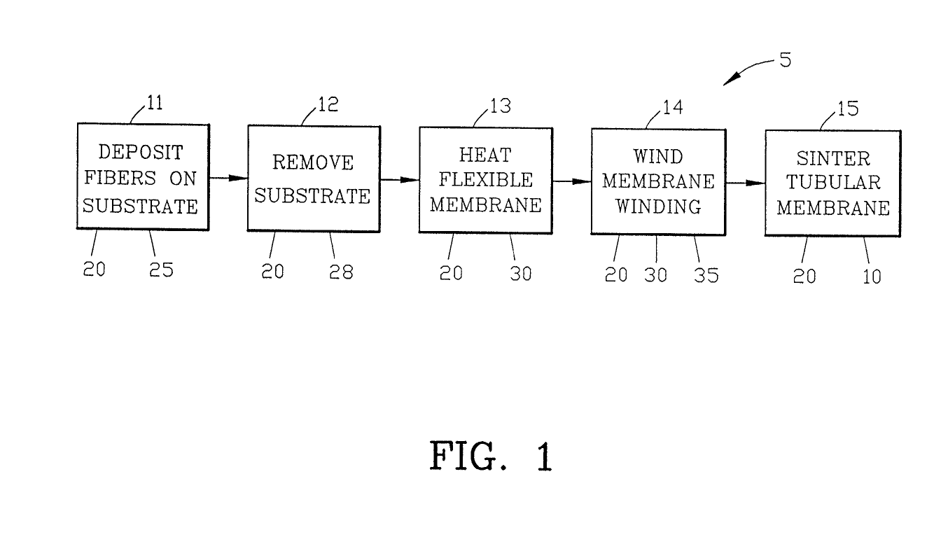

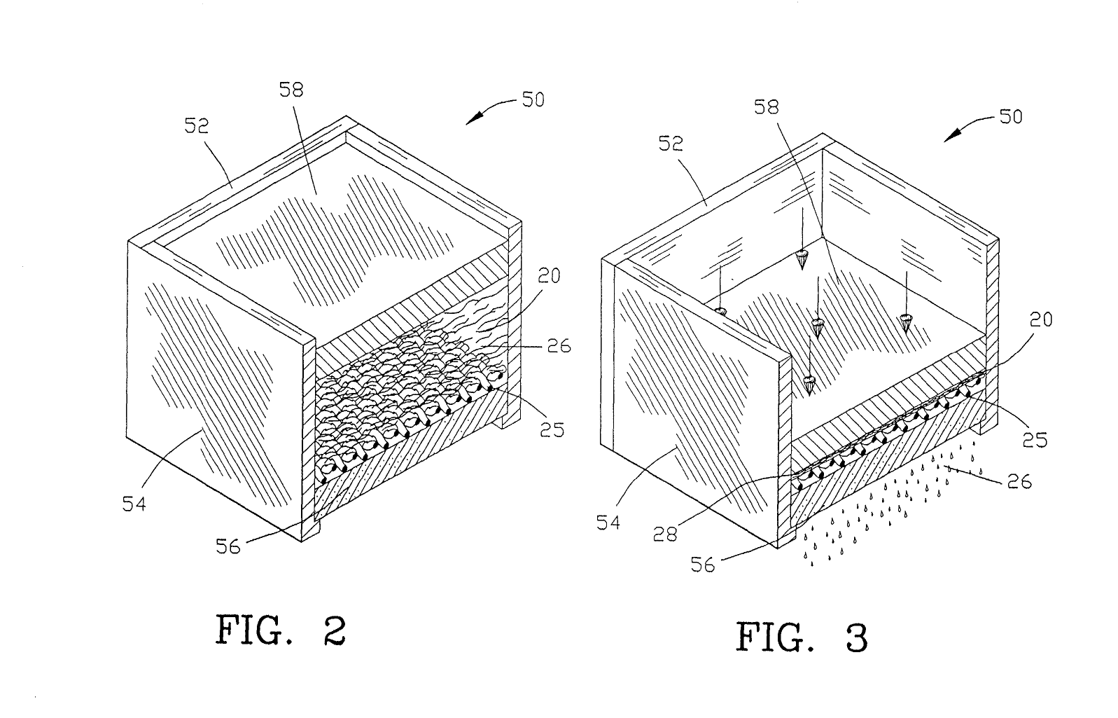

FIG. 1 is a block diagram illustrating a first process 5 of forming a tubular membrane 10. The first process 5 will be explained with reference to the formation of the tubular membrane 10 shown in FIGS. 2-10. FIG. 1 illustrates a process step 11 of depositing fine metallic fibers 20 onto a porous substrate 25. The fine metallic fibers 20 are deposited onto the porous substrate 25 to form a layer of membrane material 28 of the fine metallic fibers 20.

FIG. 2 is an isometric view illustrating the process step 11 of depositing the fine metallic fibers 20 onto the porous substrate 25. In this example, the substrate 25 is shown as a screen or a mesh substrate. The porous substrate 25 can be a coarse cylindrical filter made of metal or ceramic. The porous substrate 25 can be made from powder metal or metal fiber. In one embodiment, the process step 11 of depositing the fine metallic fibers 20 onto the substrate 25 is accomplished within a pressure vessel 50. The pressure vessel 50 comprises a container 52 having sidewalls 54 and a porous base 56. A piston 58 is slidably mounted within the container 52.

The fine metallic fibers 20 are suspended in a liquid binder 26. Preferably, each of the multiplicity of fine metallic fibers 20 is a metallic fiber formed by a wire drawing process and have a diameter between 0.001 microns and 100 microns. Preferably, the fine metallic fibers 20 have a diameter between 0.1 and 10 microns, and more preferably between 0.5 and 3 microns. One suitable method of drawing fine metallic fibers is explained in U.S. Pat. No. 6,112,395 entitled PROCESS OF MAKING FINE AND ULTRA FINE METALLIC FIBERS, the disclosure of which is hereby incorporated by reference in its entirety. The liquid binder 26 is a curable polymeric material such as an acrylic or any other suitable binder material. Another method of providing fine metallic fibers using a laser is explained in U.S. Patent Application Publication No. 20020043091 entitled APPARATUS AND METHOD FOR DRAWING CONTINUOUS FIBER, the disclosure of which is hereby incorporated by reference in its entirety. However, one skilled in that art will understand that the liquid binder 26 may be of any suitable type depending on the type of the fine metallic fibers 20 used to form the tubular membrane 10. The multiplicity of fine metallic fibers 20 are suspended within the liquid binder 26 and placed within the pressure vessel 50 to overlay the porous substrate 25.

In one embodiment, the fine metallic fibers can be made from stainless steel. In other embodiments, the metallic fibers can be made from FeCrA1, 17-4PH or other corrosion resistant metals. The metallic fibers can also be made from of a catalytically active material. In an alternative embodiment, the metallic fibers include fibers made from a base metal clad with a catalytic metal on the surface. For example, the fiber can have a base of 300 series stainless steel with a platinum surface. Other catalytic metals, such as cobalt, nickel and the like, can also be used.

FIG. 3 is an isometric view similar to FIG. 2 illustrating the process step 11 of depositing the fine metallic fibers 20 onto the porous substrate 25. A pressure is applied to the liquid binder 26 for forcing the liquid binder 26 through the porous substrate 25, thereby depositing the fine metallic fibers 20 onto the porous substrate 25. In this example, a mechanical pressure is applied to the liquid binder 26 by the piston 58 against the liquid binder 26. In the alternative, a gas pressure (not shown) may be applied to the liquid binder 26 for forcing the liquid binder 26 through the porous substrate 25 for depositing the fine metallic fibers 20 onto the porous substrate 25. In still a further alternative, a vacuum may be established beneath the porous base 56 of the pressure vessel 50 for enabling atmospheric pressure to force the liquid binder 26 through the porous substrate 25. Likewise, these or any other means of applying positive or negative pressure can be used singly or in combination.

FIG. 3 illustrates a layer of membrane material 28 of the fine metallic fibers 20 on the porous substrate 25 formed when substantially all of the excess liquid binder 26 has passed through the porous base 56. After the liquid binder 26 has passed through the porous substrate 25, the porous substrate 25 supports the layer of membrane material 28 of fine metallic fibers 20 coated with the remaining liquid binder 26. The layer of membrane material 28 of the fine metallic fibers 20 supported by the porous substrate 25 is removed from the pressure vessel 50.

As explained above, the layer of membrane material 28 of the fine metallic fibers 20 is formed on the porous substrate 25. Initially, the liquid binder 26 migrates through the porous substrate 25 in accordance with the flow characteristics of the container 52. After a partial accumulation of the fine metallic fibers 20 onto the surface of the porous substrate 25, the liquid binder 26 migrates preferentially through the areas of least accumulation of the fine metallic fibers 20 onto the surface of the porous substrate 25. Such flow carries and deposits fine metallic fibers 20 at these areas. This pressure wet lay process results in a substantially uniform porosity to the layer of membrane material 28.

The thickness and the porosity of the layer of membrane material 28 of the fine metallic fibers 20 may be preselected by controlling various parameters during the process step 11 of depositing fine metallic fibers 20 onto the substrate 25. These various parameters include the control of the volume of the liquid binder 26, the density of the fine metallic fibers 20 within the liquid binder 26, the rate of movement of the piston 58, the pressure applied to the piston 58 and the flow rate of the liquid binder 26 through the porous substrate 25.

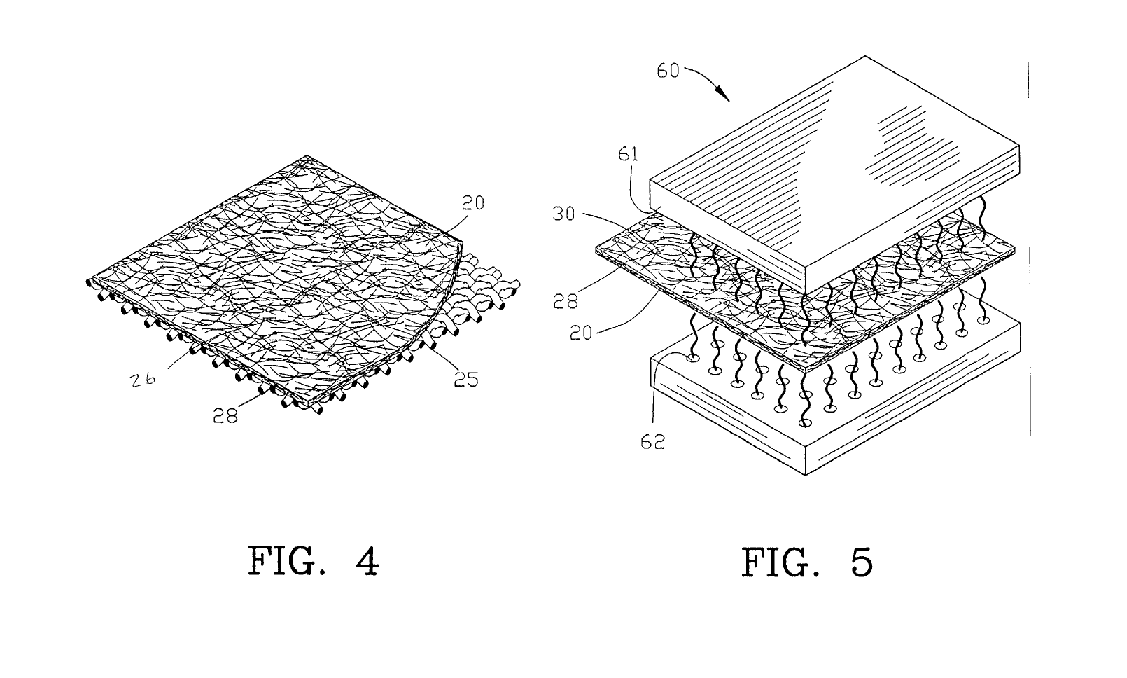

Returning to FIG. 1, the process 5 includes the process step 12 of removing the layer of membrane material 28 of fine metallic fibers 20 from the porous substrate 25. FIG. 4 illustrates that the removal of the layer of membrane material 28 of fine metallic fibers 20 from the porous substrate 25 can be performed in a conventional manner. The porous substrate 25 can also be removed by dissolving, melting or other known methods. The liquid binder 26 maintains the integrity of layer of membrane material 28 of the fine metallic fibers 20 after removal from the porous substrate 25. Preferably, the liquid binder 26 remaining within the layer of membrane material 28 of the fine metallic fibers 20 is allowed to dry or cure either in an atmospheric condition or in a drying oven or the like. In other embodiments, the porous substrate 25 is retained as a component of the membrane material 28 and is not removed.

Returning to FIG. 1, the process 5 includes the process step 13 of heating the layer of membrane material 28 of the fine metallic fibers 20 to form a flexible membrane 30. Preferably, the heating process step 13 cures the liquid binder 26 from the fine metallic fibers 20. FIG. 5 is an isometric view illustrating the heating of the layer of membrane material 28 of the fine metallic fibers 20 to form the flexible membrane 30. In this example, the layer of membrane material 28 of the fine metallic fibers 20 is passed through a heating chamber 60. In the example, the heating chamber 60 includes an upper heater 61 and a lower heater 62. In one embodiment, the heating chamber 60 contains a specialized atmosphere such as an inert atmosphere or a reducing atmosphere depending upon the type of fine metallic fibers 20 used for making the tubular membrane 10 of an embodiment of the invention. Furthermore, the process step 13 of heating the flexible membrane 30 takes place as either a continuous process or as a batch process as is well known to those skilled in the art.

Preferably, the process step 13 of heating the flexible membrane 30 is sufficient to adhere adjacent fine metallic fibers 20 to one another while enabling the flexible membrane 30 to remain pliable without loss of integrity of the flexible membrane 30. In one example, it has been found that heating at a temperature of 212 degrees Fahrenheit for a period of 20 hours within an air atmosphere allows water in the binder to evaporate and provides a suitable flexible membrane 30 made of stainless steel fibers 20 having a diameter of 2.0 microns.

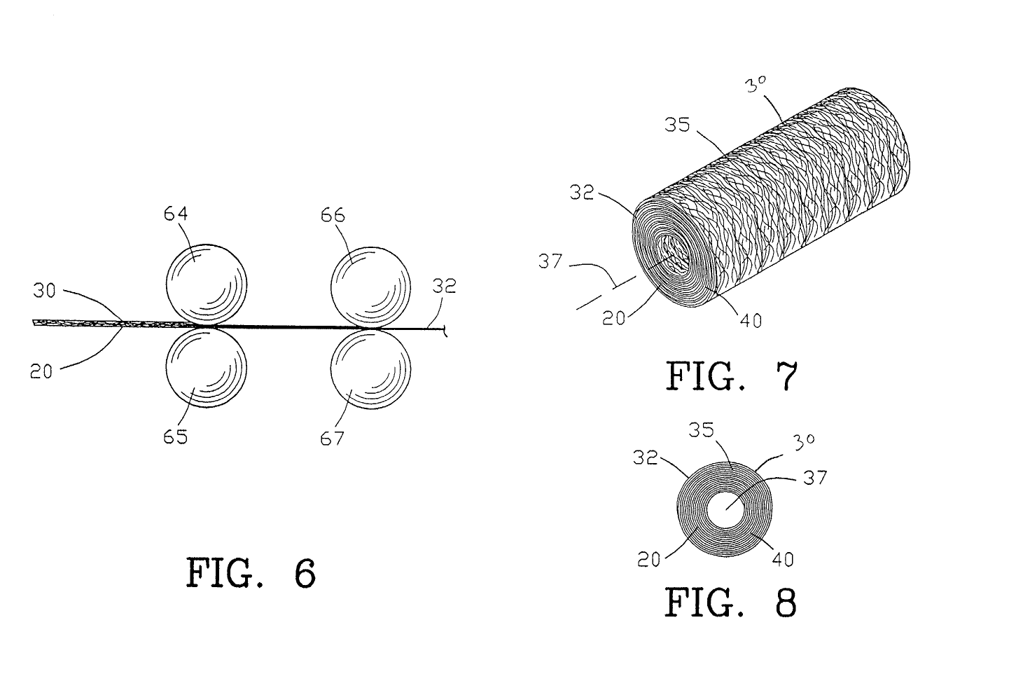

FIG. 6 is a side view illustrating rolling the flexible membrane 30 to provide a rolled flexible membrane 32. In this example, the flexible membrane 30 is passed between rollers 64 and 65 and rollers 66 and 67 for reducing the thickness of the flexible membrane 30. The rolling process transforms the flexible membrane 30 into a rolled flexible membrane 32. The process of rolling the flexible membrane 30 enables the porosity of the flexible membrane 30 to be controlled and/or adjusted to a desired level. In some instances, multiple rolling and testing may be necessary to provide the proper porosity to the rolled flexible membrane 32.

Returning to FIG. 1, the process 5 includes the process step 14 of winding the flexible membrane 30 to form a membrane winding 35. The winding of the flexible membrane 30 provides a multiplicity of overlying layers of the flexible membranes 30 for forming the membrane winding 35.

FIGS. 7-9 illustrate various views of winding the flexible membrane 30 to form the membrane winding 35. In this example, the flexible membrane 30 is wound about a cylindrical axis 37 to provide a multiplicity of overlying windings 40. The multiplicity of overlying windings 40 of the flexible membrane 30 provides the membrane winding 35.

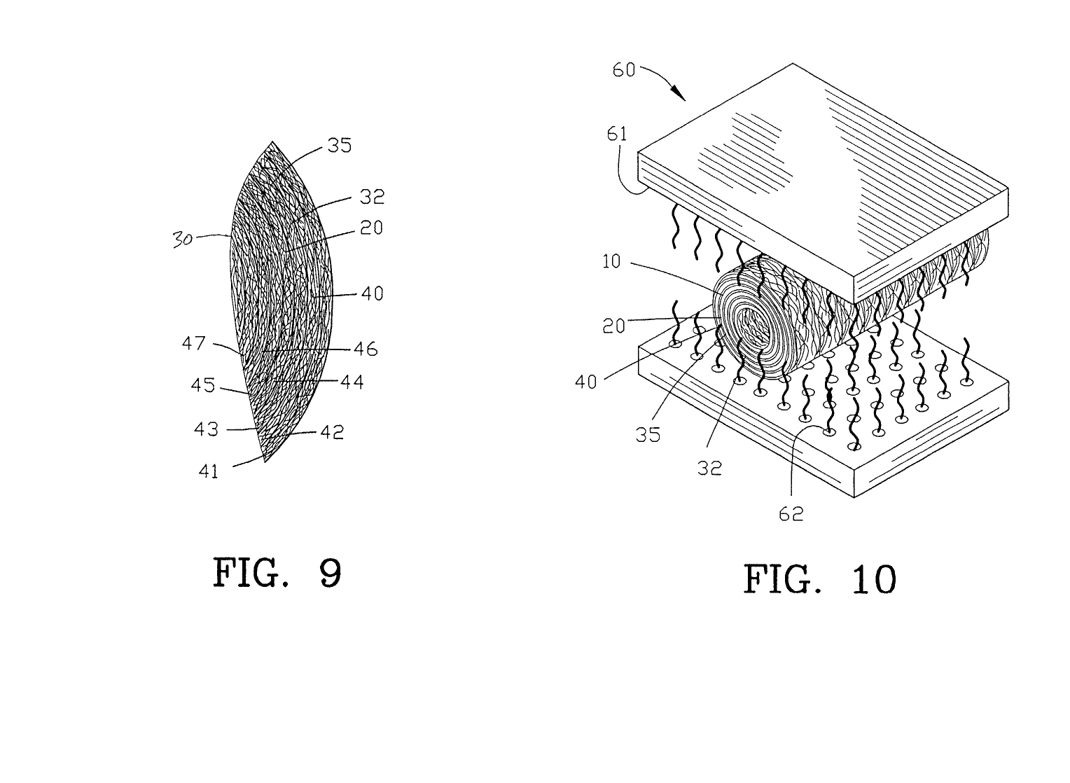

FIG. 9 is a magnifying view of a portion of FIG. 8 illustrating the multiplicity of overlying windings 40. The multiplicity of overlying windings 40 include overlying windings 41-47. The overlying windings 41-47 contact at least one adjacent overlying winding 41-47. Although this example shows seven overlying windings, one skilled in the art will understand that other numbers of overlying windings can be used. Preferably, there are between 2 and 15 overlying windings, and more preferably between 4 and 10 overlying windings.

Winding the membrane 30 may be accomplished in various ways including winding about a mandrill or the like. Although the membrane winding 35 is shown as a cylindrical winding, it should be appreciated that various other shapes of tubular membranes may be accomplished with the use of an embodiment of the invention. For example, the winding process 14 may provide a membrane winding 35 having a polygonal cross-section such as a rectangular cross-section or a square cross-section or the like. In the alternative, the winding process 14 provides a membrane winding 35 having curved cross-section such as an elliptical cross-section or any other curved cross-section.

Returning to FIG. 1, the process 5 includes the process step 15 of sintering the membrane winding 35 to provide the tubular membrane 10. The sintering of the membrane winding 35 transforms the membrane winding 35 into a substantially rigid tubular membrane 10.

FIG. 10 is an isometric view illustrating the process step 15 of sintering the membrane winding 35 to form the tubular membrane 10. The membrane winding 35 is placed in an oven 60 having a first heater 61 and a second heater 62 in a manner similar that discussed with reference to FIG. 5. The process step 15 of sintering the winding membrane 35 utilizes a higher temperature than the process step 13 of heating the flexible membrane 30.

The membrane winding 35 is heated for a time sufficient for the fine metallic fibers 20 to sinter bond with adjacent fine metallic fibers 20. In addition, the membrane winding 35 is sintered for time sufficient for the fine metallic fibers 20 of the overlying windings 41-47 to sinter bond with the fine metallic fibers 20 in an adjacent overlying windings 41-47. The sinter bonding of adjacent fine metallic fibers 20 and the sinter bonding of adjacent overlying winding 41-47 provides a substantially rigid tubular membrane 10.

In one example, it has been found that heating at a temperature of 1750 degrees Fahrenheit for a period of one hour within a partial hydrogen atmosphere provides a suitable rigid tubular membrane 10 made of stainless steel fibers 20 having a diameter of 2.0 microns. The membrane can be heated at a temperature between 1300 and 2150 degrees Fahrenheit, with the lower sintering temperatures used with smaller fibers. One skilled in the art will understand that other methods of sintering can be used such as induction sintering and infrared sintering such as is taught in U.S. Pat. No. 6,200,523 entitled APPARATUS AND METHOD OF SINTERING ELEMENTS BY INFRARED HEATING, the disclosure of which is hereby incorporated by reference in its entirety.

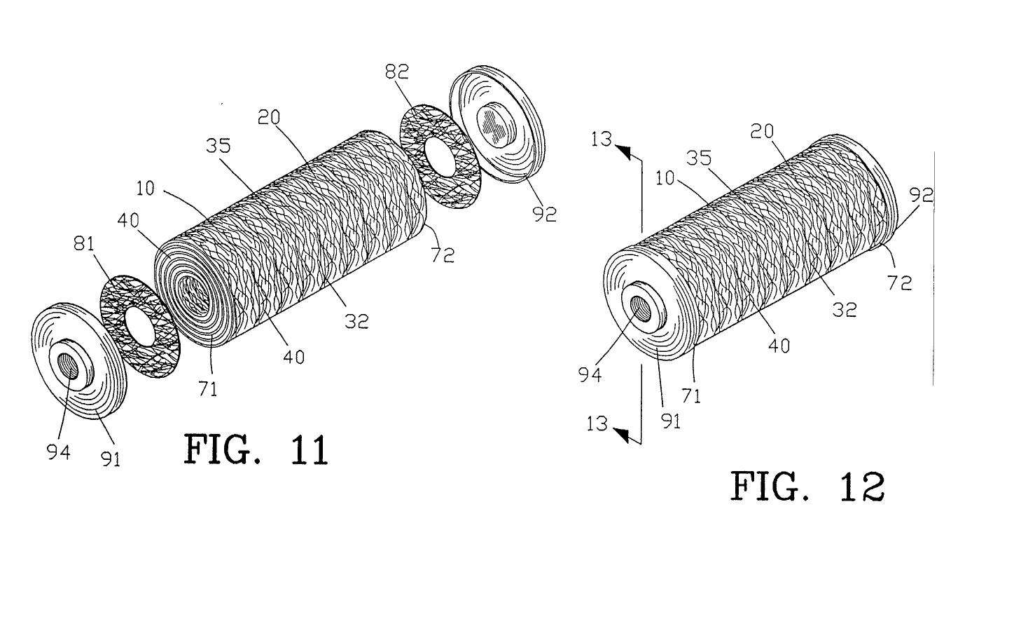

FIG. 11 depicts one embodiment wherein a first and a second end 71 and 72 of the tubular membrane 10 are provided with a first and a second sinter bonding pad 81 and 82 for affixing a first and a second end caps 91 and 92. The end caps 91 and 92 are used to affix the tubular membrane 10 to an external apparatus (not shown).

FIG. 11 is an exploded view of the first and second bonding pads 81 and 82 interposed between the first and second ends 71 and 72 of the tubular membrane 10 and the first and second end caps 91 and 92. Preferably, the sinter bonding pads 81 and 82 as well as the first and second end caps 91 and 92 are formed of the same material as the fine metallic fibers 20 found in the tubular membrane 10. Alternatively, the bonding pads 81 and 82 and end caps 91 and 92 can be formed of another suitable material.

FIG. 12 is an assembled view of the first and second end caps 91 and 92 engaging the first and second ends 71 and 72 of the tubular membrane 10. The first and second bonding pads 81 and 82 are located between the tubular membrane 10 and the first and second end caps 91 and 92.

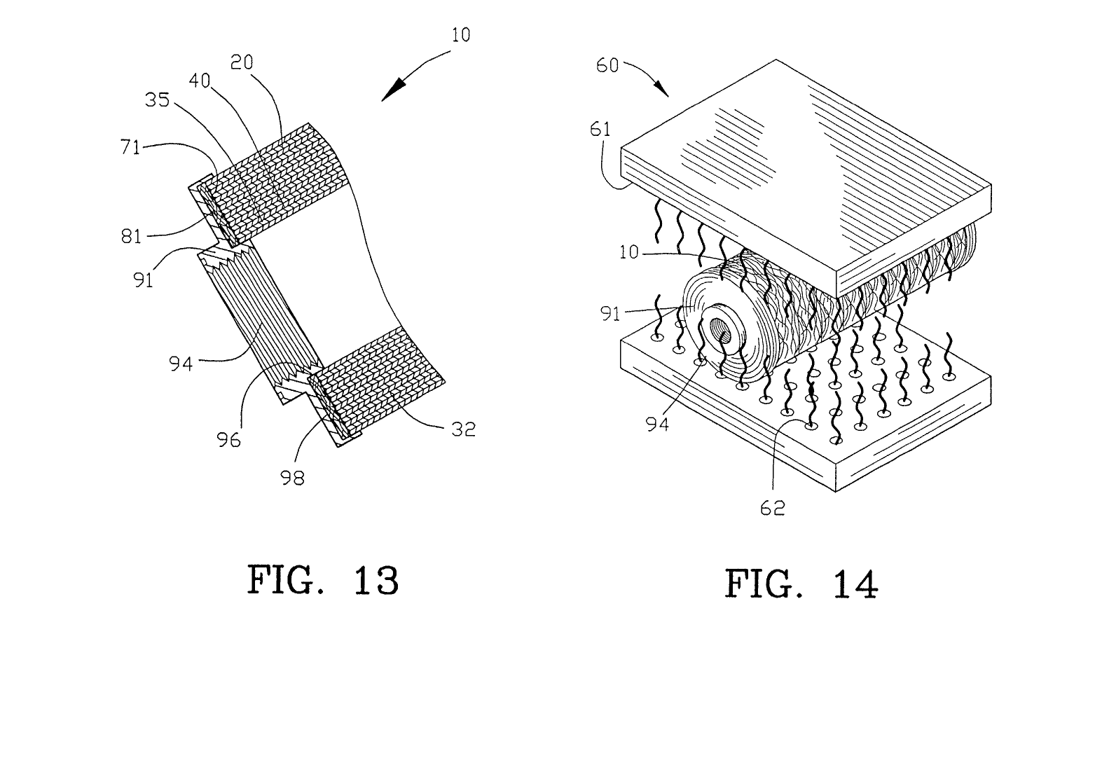

FIG. 13 is an enlarged sectional view along line 13-13 in FIG. 12 illustrating the sinter bonding pad 81 being interposed between the first end 71 of the tubular membrane 10 and the first end cap 91. The end cap 91 preferably includes an aperture 94 having threads 96 for affixing the tubular membrane 10 to an external apparatus (not shown). An annular recess 98 defined within the end cap 91 receives the sinter bonding pad 81.

FIG. 14 illustrates the process step of sintering the tubular membrane 10 with the first and second bonding pads 81 and 82 and the first and second end caps 91 and 92. Preferably, the sintering of the tubular membrane 10 is sufficient to liquefy the bonding pads 81 and 82 for bonding the first and second ends 71 and 72 of the tubular membrane 10 to the first and second end caps 91 and 92. It should be appreciated that the sintering process shown in FIG. 14 may be an additional or a replacement for the sintering process shown in FIG. 10.

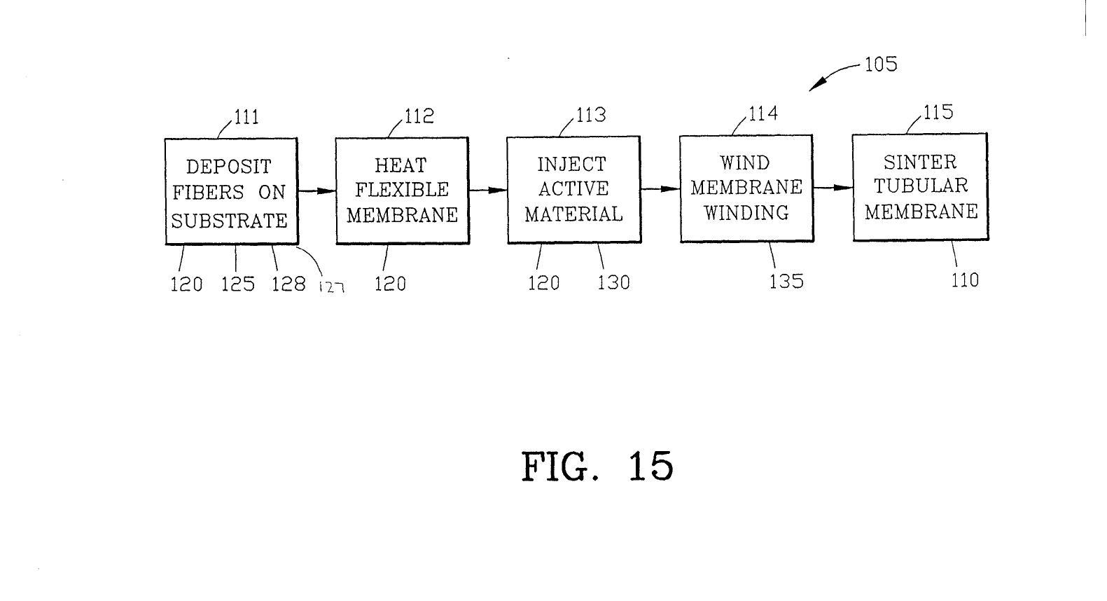

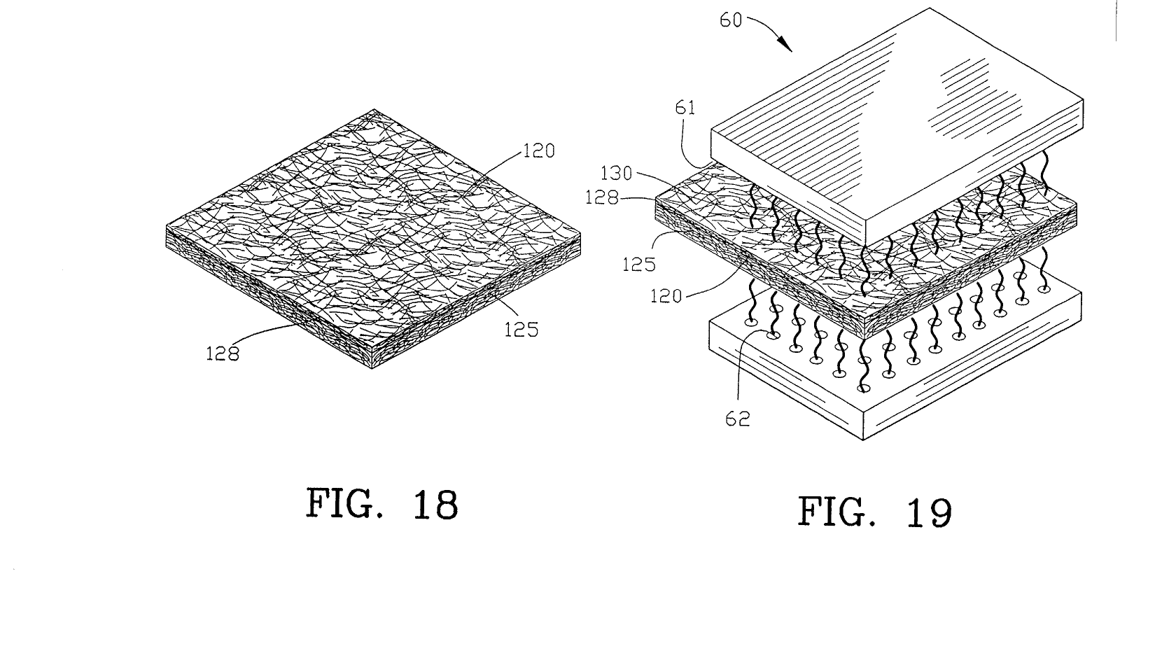

FIG. 15 is a block diagram illustrating a second process 105 of forming a tubular membrane 110. The second process 105 will be explained with reference to the formation of the tubular membrane 110 shown in FIGS. 15-27. FIG. 15 illustrates a process step 111 of depositing fine metallic fibers 120 onto a porous substrate 125. The fine metallic fibers 120 are as described previously with respect to FIG. 2. In this example, the substrate 125 is formed from substrate fibers 127 having a larger cross-section than the fine metallic fibers 120. The substrate fibers 127 are sintered to form the porous substrate 125. The fine metallic fibers 120 are deposited onto the substrate 125 to form a layer of membrane material 128 of the fine metallic fibers 120.

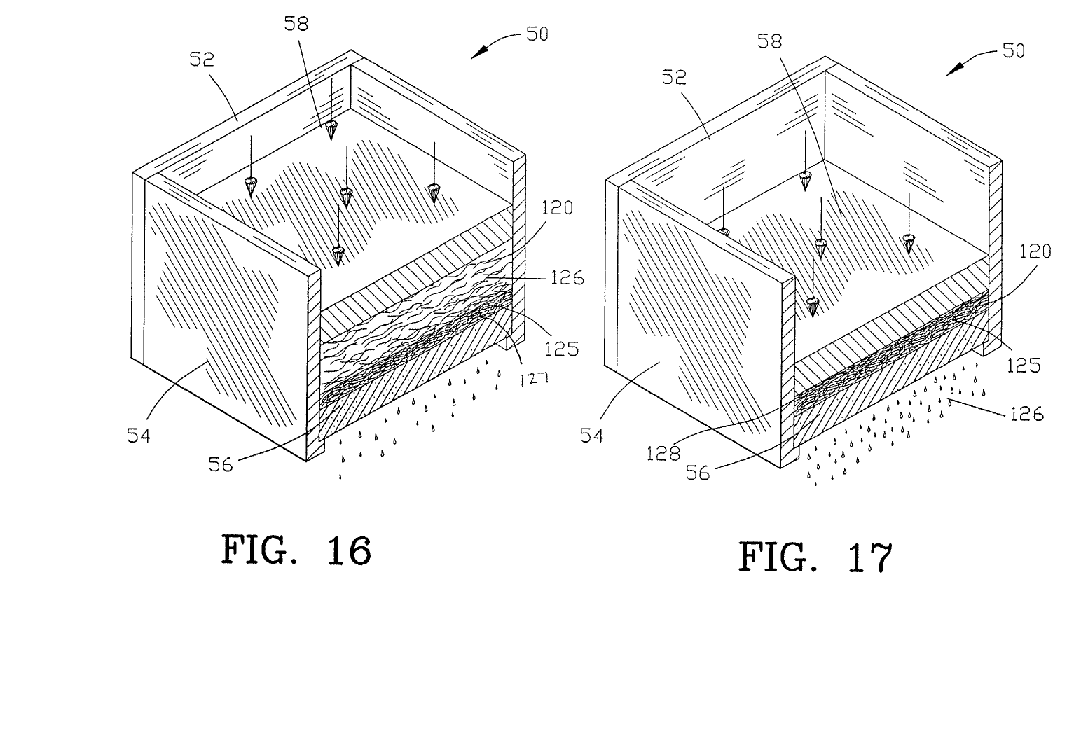

FIG. 16 is an isometric view illustrating the process 111 of depositing the fine metallic fibers 120 onto the porous substrate 125. The process step 111 of depositing the fine metallic fibers 120 onto the substrate 125 is accomplished within a pressure vessel 50 as described previously with respect to FIG. 2. The fine metallic fibers 120 are suspended in a liquid binder 126 such as a curable polymeric material and placed within the pressure vessel 50 to overlay the porous substrate 125.

FIG. 17 is an isometric view similar to FIG. 16 illustrating the continued process step 111 of depositing the fine metallic fibers 120 onto the porous substrate 125. A pressure is applied to the liquid binder 126 for forcing the liquid binder 126 through the porous substrate 125 for depositing the fine metallic fibers 120 onto the porous substrate 125. After an excess portion of the liquid binder 126 has passed through the porous substrate 125, the porous substrate 125 supports the layer of membrane material 128 of fine metallic fibers 120 coated with the remaining liquid binder 126. The layer of membrane material 128 of the fine metallic fibers 120 supported by the porous substrate 125 is removed from the pressure vessel 50. The liquid binder 126 remaining within the layer of membrane material 128 of the fine metallic fibers 120 is allowed to dry or cure either in an atmospheric condition or in a drying oven or the like.

Returning to FIG. 15, the second process 105 includes a process step 112 of heating the layer of membrane material 128 of the fine metallic fibers 20 to form a flexible membrane 130. Preferably, the heating process step 113 liberates the cured liquid binder 126 from the fine metallic fibers 120 and adheres the fine metallic fibers 120 to adjacent fine fibers 120 to form the flexible membrane 130.

FIG. 19 is an isometric view illustrating the heating of the layer of membrane material 128 of the fine metallic fibers 120 to form the flexible membrane 130. The layer of membrane material 128 of the fine metallic fibers 120 is passed through the heating chamber 60 as described previously.

In one embodiment, as depicted in FIG. 20, the flexible membrane 130 is rolled to provide a rolled flexible membrane 132. The flexible membrane 130 is passed between rollers 64 and 65 and rollers 66 and 67 for reducing the thickness of a flexible membrane 130 as described previously.

Returning to FIG. 15, the second process 105 includes the process step 113 of injecting a catalytically active material 150 into the substrate fibers 127. The larger cross-section of the substrate fibers 127 provides large pores 154 relative to the small pores 156 of the fine metallic fibers 120. The catalytically active material 150 is received within the large pores 154 between the substrate fibers 127 to be dispersed between the substrate fibers 127 of the substrate 125.

FIG. 21 is a magnified side view of FIG. 20 illustrating a first catalytically active material 151 dispersed between the substrate fibers 127 of the substrate 125. In this example, the first active material 151 is shown as catalytically active particles 151 received within the large pores 154 of the substrate 125.

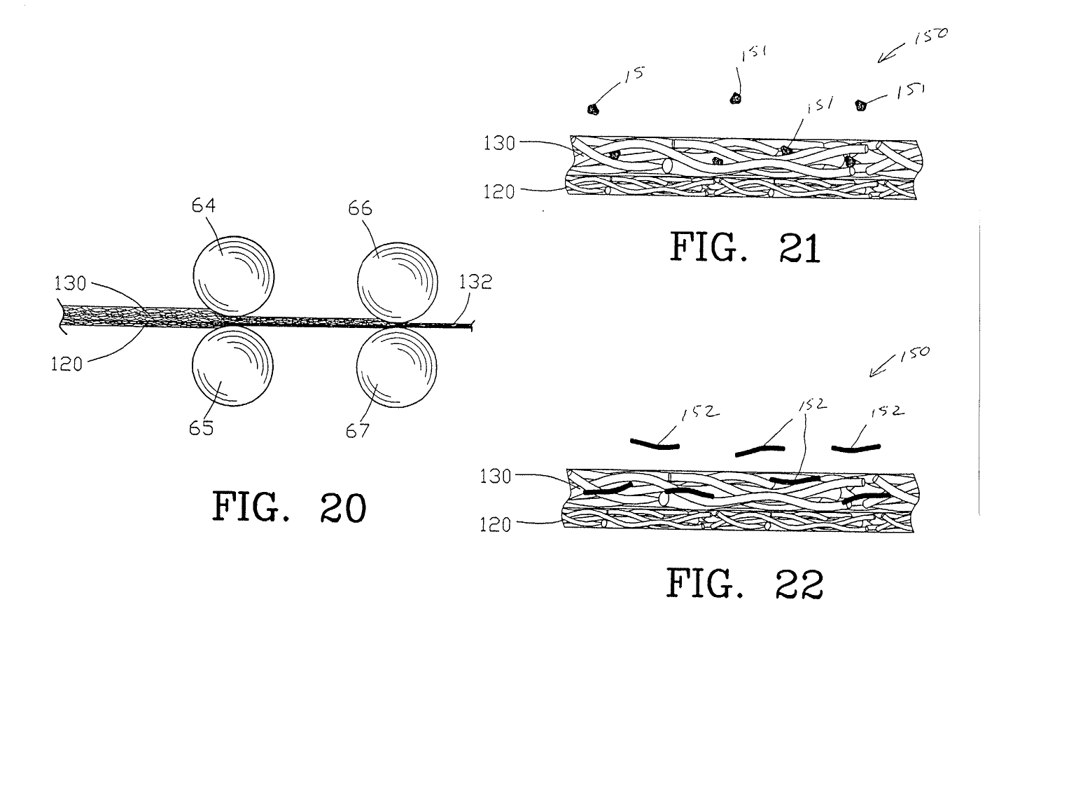

FIG. 22 is a magnified side view of FIG. 20 illustrating a second catalytically active material 152 dispersed between the substrate fibers 127 of the substrate 125. In this example, the second catalytically active material 152 is shown as active fibers 152 received within the large pores 154 of the substrate 125.

The catalytically active material 150 may be injected and dispersed into the large pores 154 of the substrate fibers 127 in a variety of ways. The catalytically active material 150 may be injected and dispersed into the large pores 154 by an air injection lay process or a wet lay injection process. In addition, the catalytically active material 150 may be injected and dispersed into the large pores 154 by a pasting process. The catalytically active material 150 can be dispersed into the fine metallic fibers 120 before the fibers are deposited onto the porous substrate 125 shown in FIG. 16.

Returning to FIG. 15, the second process 105 includes a process step 114 of winding the substrate 125 and the flexible membrane 130 to form a membrane winding 135. The winding of the substrate 125 and the flexible membrane 130 provide a multiplicity of overlying winding 140 of the substrate 125 and the flexible membrane 130 provides the membrane winding 135.

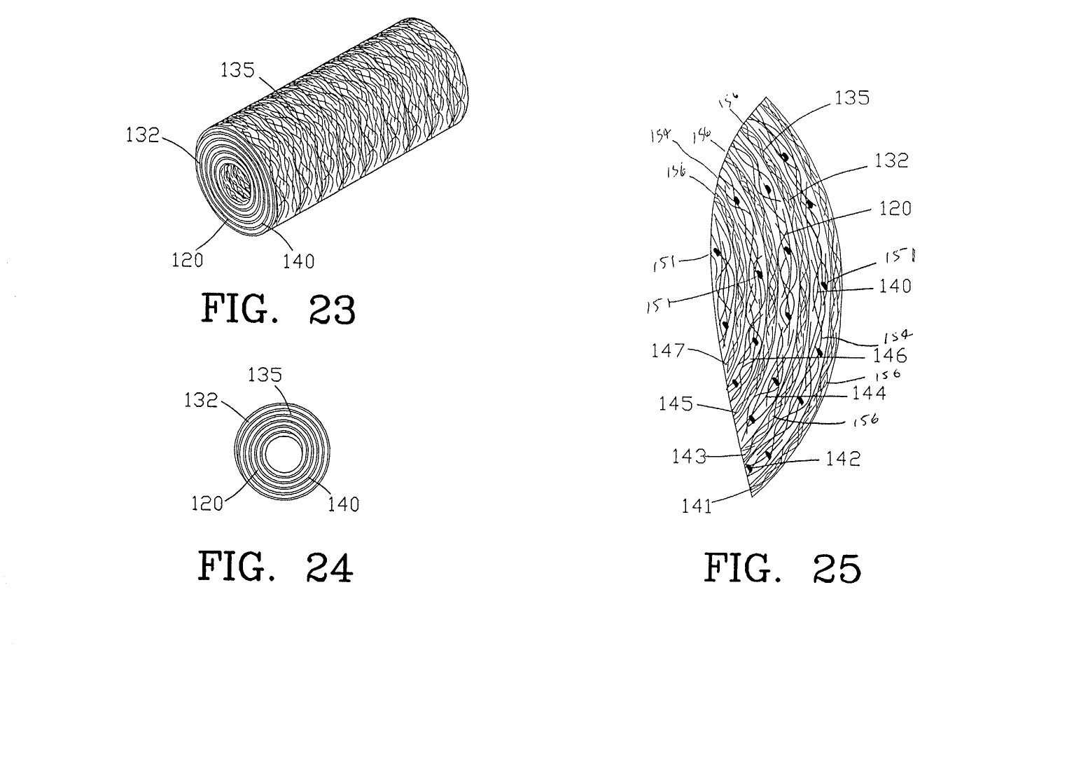

FIGS. 23 and 24 are various views illustrating the winding of the substrate 125 and the flexible membrane 130 to form the membrane winding 135. In this example, the substrate 125 and the flexible membrane 130 are wound about a cylindrical axis 137 to provide a multiplicity of overlying winding 140. The multiplicity of overlying winding 140 of the flexible membrane 130 provides the membrane winding 135.

FIG. 25 is a magnifying view of a portion of FIG. 24 with the catalytically active particles 151 of FIG. 21 injected within the multiplicity of overlying windings 140. The multiplicity of overlying windings 140 includes overlying windings 141-147. The overlying windings 141-147 contact adjacent overlying windings 141-147.

The overlying windings 141, 143, 145 and 147 comprise the flexible membrane 130 whereas the overlying windings 142, 144 and 146 comprise the substrate 125 containing the active particles 151. The active particles 151 are entrapped within the large pores 154 by the small pores 156 of the fine metallic fibers 120. The alternating overlying windings 141, 143, 145 and 147 of the flexible membrane 130 prevent migration of the active particles 151 from the overlying windings 142, 144 and 146 of the substrate 125.

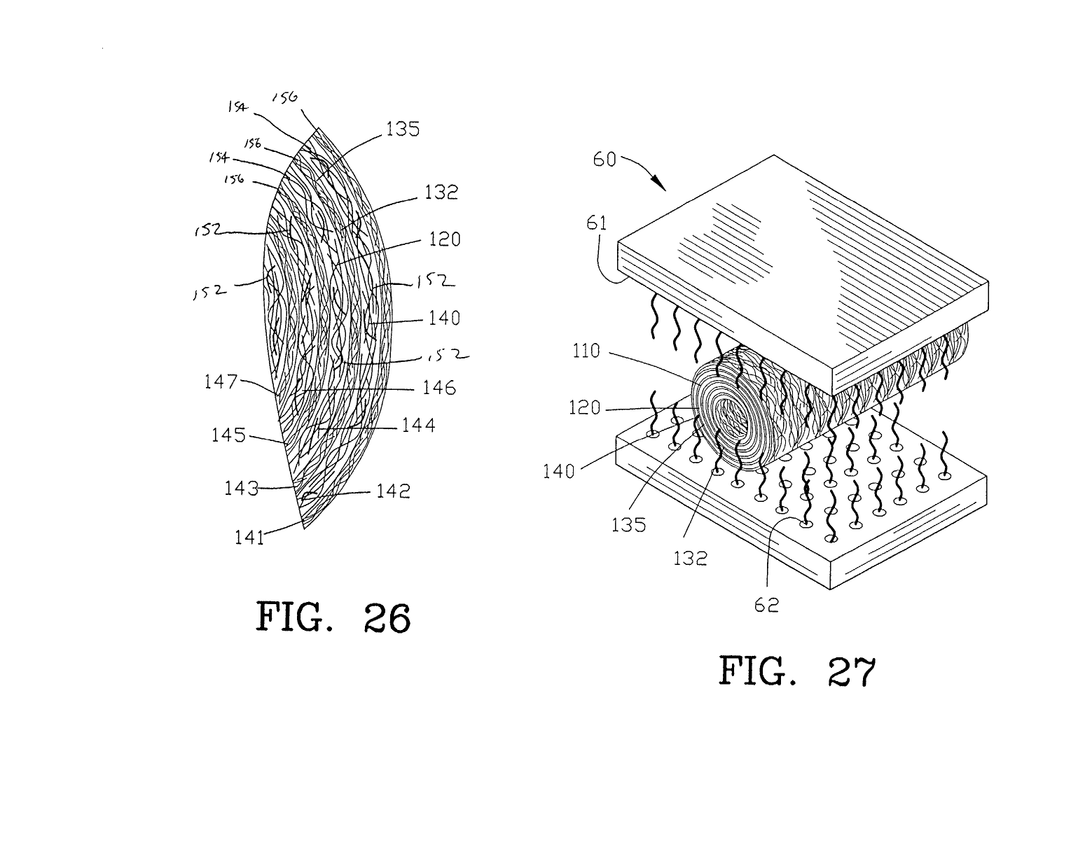

FIG. 26 is a magnifying view of a portion of FIG. 24 with the catalytically active fibers 152 of FIG. 22 injected within the multiplicity of overlying windings 140. The multiplicity of overlying windings 140 includes overlying windings 141-147. The overlying windings 141-147 contact adjacent overlying windings 141-147.

The catalytically active fibers 152 are entrapped within the large pores 154 by the small pores 156 of the fine metallic fibers 120. The alternating overlying windings 141, 143, 145 and 147 of the flexible membrane 130 prevent migration of the active fibers 152 from the overlying windings 142, 144 and 146 of the substrate 125.

Returning to FIG. 15, the second process 105 includes a process step 115 of sintering the membrane winding 135 to provide the tubular membrane 110. The sintering of the membrane winding 135 transforms the membrane winding 135 into a substantially rigid tubular membrane 110.

FIG. 27 is an isometric view illustrating the process step 115 of sintering the membrane winding 135 to form the tubular membrane 110. The membrane winding 130 is placed in an oven 60 in a manner similar to FIG. 10.

Specific blocks, sections, devices, functions and modules have been set forth. However, a skilled technologist will recognize that there are many ways to partition the system of the invention, and that there are many parts, components, modules or functions that may be substituted for those listed above. While the above detailed description has shown, described, and pointed out fundamental novel features of the invention as applied to various embodiments, it will be understood that various omissions and substitutions and changes in the form and details of the system illustrated may be made by those skilled in the art, without departing from the intent of the invention.

What is claimed is:

1. A process of making a tubular membrane from a multiplicity of fine metallic fibers, comprising:
suspending the multiplicity of fine metallic fibers within a liquid binder;
depositing the fine metallic fibers onto a porous substrate by applying a pressure, thereby forcing the liquid binder through the porous substrate;
heating the deposited fine metallic fibers to form a flexible membrane;
winding the flexible membrane to form a tubular membrane winding; and
sintering the membrane winding to form the tubular membrane.

2. A process of making a tubular membrane as set forth in claim 1, wherein the fine metallic fibers comprise fibers formed by a metallic wire drawing process.

3. A process of making a tubular membrane as set forth in claim 1, wherein the act of depositing the fine metallic fibers comprises applying a mechanical pressure.

4. A process of making a tubular membrane as set forth in claim 3, wherein the a mechanical pressure is applied with a piston.

5. A process of making a tubular membrane as set forth in claim 1, wherein the porous substrate comprises fibers that are larger than the fine metallic fibers.

6. A process of making a tubular membrane as set forth in claim 1, further including removing the deposited fine metallic fibers from the substrate.

7. A process of making a tubular membrane as set forth in claim 1, wherein the fine metallic fibers are sintered to the substrate.

8. A process of making a tubular membrane as set forth in claim 1, wherein the deposited fine metallic fibers are heated for a time sufficient for adhering the fine metallic fibers to adjacent fine metallic fibers to form the flexible membrane.

9. A process of making a tubular membrane as set forth in claim 1, further comprising rolling the flexible membrane.

10. A process of making a tubular membrane as set forth in claim 9, wherein the flexible membrane is wound about a mandrill to provide multiple overlying layers of the flexible membrane.

11. A process of making a tubular membrane as set forth in claim 1, wherein the fine metallic fibers have a catalytic property.

12. A process of making a tubular membrane as set forth in claim 1, wherein the act of sintering the membrane winding comprises sintering the membrane winding for a time sufficient for forming a substantially rigid tubular membrane.

13. A process of making a tubular membrane as set forth in claim 1, further comprising dispersing an active substance into the flexible membrane.

14. A process of making a membrane from a multiplicity of fine metallic fibers, comprising:
suspending the multiplicity of fine metallic fibers within a liquid binder;
pouring the fine metallic fibers with the liquid binder onto a porous substrate located within a pressure vessel;
applying a pressure to the liquid binder for forcing the liquid binder through the porous substrate, thereby depositing the fine metallic fibers onto the porous substrate;
drying the deposited fine metallic fibers and the porous substrate;
heating the deposited fine metallic fibers for a time sufficient for adhering the fine metallic fibers to adjacent fine metallic fibers to form a flexible membrane;
winding the flexible membrane to form a tubular membrane with multiple overlying layers of the flexible membrane to form membrane winding; and
sintering the membrane winding for forming a substantially rigid tubular membrane.

15. A process of making a tubular membrane as set forth in claim 14, wherein the liquid binder comprises a curable binder.

16. A process of making a tubular membrane as set forth in claim 14, wherein the act of applying a pressure to the liquid binder comprises applying a gas pressure to the liquid binder.

17. A process of making a tubular membrane as set forth in claim 14, wherein the act of applying a pressure to the liquid binder includes applying a mechanical pressure to the liquid binder.

18. A process of making a tubular membrane as set forth in claim 17, wherein the mechanical pressure is applied with a hydraulically operated piston.

19. A process of making a tubular membrane as set forth in claim 14, further comprising dispersing a catalytically active substance into the flexible membrane.

20. A process of making a tubular membrane as set forth in claim 14, wherein the act of drying the deposited fine metallic fibers and the porous substrate includes drying the liquid binder.

21. A process of making a tubular membrane as set forth in claim 14, wherein the multiplicity of fine metallic fibers comprises fine metallic fibers having catalytic properties.

22. A process of making a tubular membrane as set forth in claim 14, wherein the act of winding the flexible membrane includes winding the flexible membrane about a tubular axis for providing multiple overlying layers of the flexible membrane for forming the membrane winding.

23. A process of making a tubular membrane as set forth in claim 14, wherein the act of winding the flexible membrane includes winding the flexible membrane in multiple overlying layers.

24. A process of making a tubular membrane as set forth in claim 14, wherein the act of sintering the tubular membrane comprises sintering the membrane winding for a time sufficient for forming a substantially rigid tubular membrane.

25. A process of making a membrane from a multiplicity of fine metallic fibers, comprising:
suspending the multiplicity of fine metallic fibers within a liquid binder, wherein said fine metallic fibers have catalytic properties.
pouring the fine metallic fibers with the liquid binder onto a porous substrate located within a pressure vessel;
applying a mechanical pressure to the liquid binder for forcing the liquid binder through the porous substrate thereby depositing the fine metallic fibers onto the porous substrate;
drying the deposited fine metallic fibers and the porous substrate;
heating the deposited fine metallic fibers for a time sufficient for adhering the fine metallic fibers to adjacent fine metallic fibers to form a flexible membrane;
dispersing a catalytically active substance into the flexible membrane;
winding the flexible membrane to form a tubular membrane with multiple overlying layers of the flexible membrane to form membrane winding; and
sintering the membrane winding for forming a substantially rigid tubular membrane.

26. A process of making a tubular membrane as set forth in claim 25, wherein the multiplicity of fine metallic fibers comprises fine metallic fibers having a diameter between 0.001 and 100 microns within a curable liquid binder.

27. A process of making a tubular membrane as set forth in claim 25, wherein the act of applying a pressure to the liquid binder includes applying a mechanical pressure to the liquid binder with a hydraulically operated piston.

28. A tubular membrane formed from a multiplicity of fine metallic fibers, comprising:
a flexible sheet of membrane formed from a multiplicity of fine metallic fibers;
said flexible sheet of membrane being wound in multiple overlying layers about a generally central axis to form a membrane winding; and
sinter bonds of said membrane winding for bonding said multiple overlying layers to adjacent overlying layers of said flexible sheet of membrane for forming a substantially rigid tubular membrane.

29. A tubular membrane formed from a multiplicity of fine metallic fibers as set forth in claim 28, wherein said multiplicity of fine metallic fibers are fine metallic fiber.

30. A tubular membrane formed from a multiplicity of fine metallic fibers as set forth in claim 28, wherein said multiplicity of fine metallic fibers comprises fibers having a diameter between 0.1 and 100 microns.

31. A tubular membrane formed from a multiplicity of fine metallic fibers as set forth in claim 28, wherein said multiplicity of fine metallic fibers comprises fibers formed in a wire drawing process.

32. A tubular membrane formed from a multiplicity of fine metallic fibers as set forth in claim 28, further including a catalytically active material dispersed in the flexible sheet of membrane.

33. A tubular membrane formed from a multiplicity of fine metallic fibers as set forth in claim 28, wherein said fine metallic fibers comprise fibers having a catalytic property.

34. A tubular membrane formed from a multiplicity of fine metallic fibers as set forth in claim 28, wherein said flexible sheet of membrane is supported by a porous substrate.

35. A tubular membrane formed from a multiplicity of fine metallic fibers as set forth in claim 34, wherein said porous substrate is interleaved between said multiple overlying layers of said flexible sheet of membrane.

36. A tubular membrane formed from a multiplicity of fine metallic fibers as set forth in claim 35, wherein a catalytically active substance injected into said porous substrate with said sheet of membrane entrapping said active substance between said multiple overlying layers of said sheet of membrane.

37. A tubular membrane formed from a process comprising:
suspending a multiplicity of fine metallic fibers within a liquid binder;
depositing the fine metallic fibers onto a porous substrate by applying a pressure thereby forcing the liquid binder through the porous substrate;
heating the deposited fine metallic fibers to form a flexible membrane;
winding the flexible membrane to form a membrane winding with multiple overlying layers of the flexible membrane; and
sintering the membrane winding to form the tubular membrane.
